(19) United States
(12) Patent Application Publication
(10) Pub. No.: US 2023/0321466 A1
(43) Pub. Date: Oct. 12, 2023

(54) COMPACT POWERED AIR PURIFYING RESPIRATOR HAVING IMPROVED AIRFLOW EFFICIENCY

(71) Applicant: D. Wheatley Enterprises, Inc., Belcamp, MD (US)

(72) Inventors: Ken Ikemoto, Belcamp, MD (US); Collin Smith, Belcamp, MD (US); Corey Zamenski, Belcamp, MD (US); David Hanson, Street, MD (US)

(21) Appl. No.: 18/190,538

(22) Filed: Mar. 27, 2023

Related U.S. Application Data
(60) Provisional application No. 63/324,045, filed on Mar. 26, 2022.

(51) Int. Cl. A62B 18/04; A62B 7/10; A62B 23/02; A62B 18/02

(52) U.S. Cl. CPC A62B 18/045; A62B 7/10; A62B 18/02; A62B 23/02

(57) ABSTRACT

A compact, mask-mountable powered air purifying respirator (“PAPR”) includes a housing and an impeller driven by a motor to draw air in through an inlet in the housing and direct the air to an outlet at an opposite end of the housing. The impeller comprises S-shaped fan blades that direct the air radially outward from the bottom of the impeller. The radial airflow meets S-shaped fins on a flow straightener that redirect the airflow downward through the PAPR housing outlet. The fan blades and flow straightener drive the airflow directly and efficiently, without unnecessary travel of air through the PAPR assembly, thus providing an improved airflow efficiency.

### CROSS-REFERENCE TO RELATED APPLICATIONS

This application claims the benefit of U.S. Provisional Patent Application No. 63/324,045 titled “POWERED AIR PURIFYING RESPIRATOR,” filed by the Applicant herein on Mar. 26, 2022, the specification of which is incorporated herein by reference in its entirety.

### FIELD OF THE INVENTION

This invention relates generally to powered air purifying respirators, and more particularly to a compact or “micro” sized powered air purifying respirator configured for removable attachment to a filter canister and a respirator mask that provides improved airflow efficiency over previously known PAPR configurations.

### BACKGROUND OF THE INVENTION

Powered air purifying respirators (“PAPR”S) are frequently used by emergency response personnel, industrial workers, healthcare workers, and others operating in potentially hazardous environments to provide respiratory protection against airborne contaminants. Typical PAPR configurations include a blower unit that draws air through a filter cartridge attached to the inlet of the blower and an outlet that is in ultimate fluid communication with the breathing zone of a user’s equipment, such as the breathing zone inside of a protective mask, via a hose that attaches to both the blower outlet and the user’s protective mask. A challenge in PAPR selection and configuration exists in finding one that provides sufficient airflow to ensure adequate respiratory protection while maintaining comfort and overall mobility for the user.

The ability of a PAPR to provide such protection depends on the PAPR’s ability to successfully filter and purify air before it is delivered to the operator, along with the PAPR’s airflow efficiency. Unfortunately, previously known PAPR configurations have frequently suffered from inefficient airflows, resulting in reduced filter performance, reduced respiratory protection for the user, increased energy consumption, and at times increased user discomfort that may result from excessive heat and humidity. For example, previously known PAPR configurations have often employed a convoluted or tortuous air flow path through the blower unit, which results in pressure losses and increased power consumption. Even further, previously known PAPR configurations have tended to be bulky and not easily mountable directly to a user’s protective mask, which in turn may impede the user’s ability to move freely.

Thus, there remains a need in the art for a PAPR that can provide improved airflow efficiency over previously known configurations, and that is able to provide such improved performance in a compact configuration that may be directly mounted to a user’s mask so as to ensure user mobility and comfort.

### SUMMARY OF THE INVENTION

In accordance with certain aspects of the invention, a compact, mask-mountable PAPR is provided that improves airflow efficiency over previously known PAPR configurations. The PAPR draws in air through an inlet in an upper housing and directs the air to an outlet in a lower housing, which in turn directs the filtered air to the wearer’s breathing zone, such as inside of the user’s protective mask. A motor-operated impeller is rotated to cause air to be drawn in through the housing inlet, and generally S-shaped fan blades on the impeller direct the air radially outward from the bottom of the impeller. The radial airflow immediately meets S-shaped fins on a flow straightener that redirect the airflow downward through the housing outlet. The fan blades on the impeller and the fins on the flow straightener are particularly configured to more immediately and directly drive the airflow downward without excess travel of air through the interior of the PAPR assembly, thus reducing the amount of excess travel of air through the interior of the PAPR assembly and associated pressure losses, and improving airflow efficiency over previously known devices.

In accordance with certain aspects of an embodiment of the invention, the PAPR is compact and mountable directly to a user’s protective mask. The improved airflow efficiency of a PAPR configured in accordance with at least certain aspects of the invention allows for increased performance and respiratory protection with decreased energy consumption, while the compact and mountable design provides greater freedom of movement for the user.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The novel features of the invention are set forth with particularity in the appended claims. A better understanding of the features and advantages of the present invention will be obtained by reference to the following detailed description that sets forth illustrative embodiments, in which the principles of the invention are utilized. The present invention is illustrated by way of example, and not by way of limitation, in the figures of the accompanying drawings, in which like reference numerals refer to similar elements, and in which:

FIG. 1 is a top perspective view of a compact, mask-mountable PAPR according to certain aspects of an embodiment of the invention.

FIG. 2 is a bottom perspective view of the compact, mask mountable PAPR of FIG. 1.

FIG. 3 is a side view of the compact, mask mountable PAPR of FIG. 1.

FIG. 4 is a side, cross-sectional view of the compact, mask mountable PAPR of FIG. 1 along section line A-A of FIG. 3.

FIG. 5 is an exploded view of the compact, mask mountable PAPR of FIG. 1.

FIG. 6 is a side view of the upper housing of the compact, mask mountable PAPR of FIG. 1.

FIG. 7 is a side, cross-sectional view of the upper housing along section line B-B of FIG. 6.

FIG. 8 is a bottom view of the upper housing of FIG. 6.

FIG. 9 is a side view of the lower housing of the compact, mask mountable PAPR of FIG. 1.

FIG. 10 is a side, cross-sectional view of the lower housing along section line C-C of FIG. 9.

FIG. 11 is a top view of the lower housing of FIG. 9.

FIG. 12 is a bottom view of the lower housing of FIG. 9.

FIG. 13 is a side view of the impeller of the compact, mask mountable PAPR of FIG. 1.

FIG. 14 is a side, cross-sectional view of the impeller along section line D-D of FIG. 13.

FIG. 15 is a top view of the impeller of FIG. 13.

FIG. 16 is a bottom view of the impeller of FIG. 13.

FIG. 17 is a top perspective view of the impeller of FIG. 13.

FIG. 18 is a side view of the flow straightener of the compact, mask mountable PAPR of FIG. 1.

FIG. 19 is a side, cross-sectional view of the flow straightener along section line E-E of FIG. 18.

FIG. 20 is a top view of the flow straightener of FIG. 18.

FIG. 21 is a bottom view of the flow straightener of FIG. 18.

FIG. 22 is a top perspective view of the flow straightener of FIG. 18.

FIG. 23 is a top perspective view and FIG. 24 is a top view of the flow straightener installed in the lower housing of the compact, mask mountable PAPR of FIG. 1.

FIG. 25 is a side detail view showing relative positions of the impeller and the flow straightener.

FIG. 26 is a schematic view of airflow through the compact, mask mountable PAPR of FIG. 1.

### DETAILED DESCRIPTION OF THE PREFERRED EMBODIMENT

The invention may be understood by referring to the following description and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

Unless otherwise indicated, all dimensions shown in the attached drawings are exemplary only and should not be construed as limiting the scope of the invention to those specific dimensions.

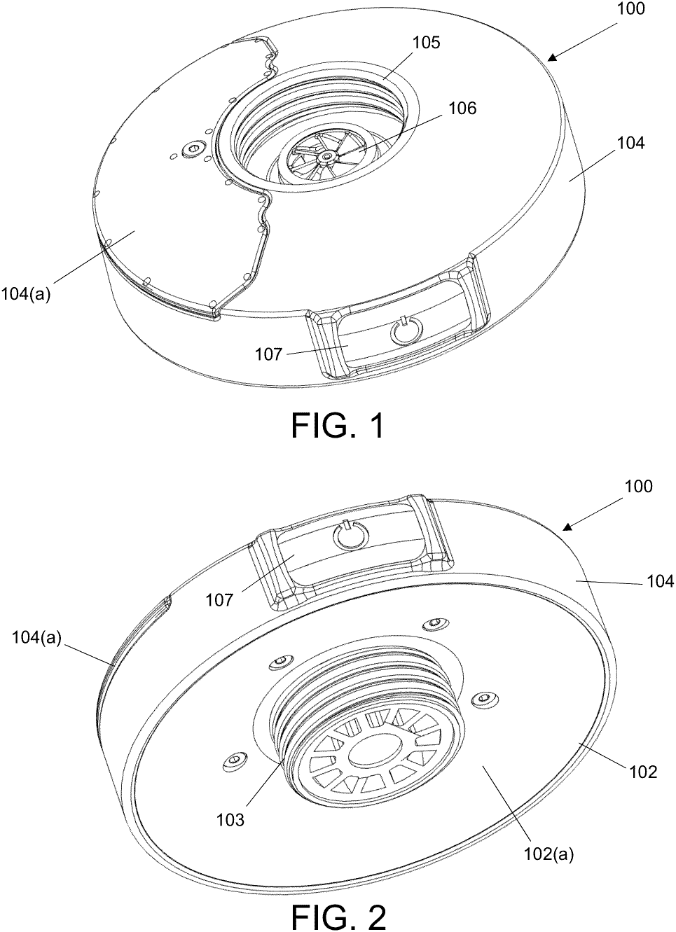

In accordance with certain aspects of an exemplary embodiment and with particular reference to FIGS. 1 and 2, a powered air purifying respirator (“PAPR”) 100 is provided having an upper housing 104 and a lower housing 102 that are affixed to one another to form an enclosed, single PAPR body. Upper housing 104 includes an internally threaded inlet opening 105 that is configured to receive a filter canister, such as an externally threaded 40 mm filter canister having a configuration well known to those of ordinary skill in the art. A centrifugal impeller 106 is rotatably mounted within the PAPR body and extends through a base of inlet opening 105, such that when a filter canister is attached to inlet opening 105 and impeller 106 is rotating, air is drawn through the filter canister and into the body of PAPR 100. Such filtered air is then directed through the body of PAPR 100, as discussed in greater detail below, to and out from externally threaded outlet opening 103 that is configured for threaded attachment to a respirator mask, such as an M53 or FM54 respirator mask. This configuration of PAPR 100 thus allows air to be drawn into PAPR 100 through inlet opening 105, drawing the air first through a filter canister (not shown) that is attached to inlet opening 105 when impeller 106 is rotating, and in turn deliver that air to outlet opening 103 for downstream delivery to the interior of a user’s respiratory mask (not shown), enabling the user to breath filtered air.

Preferably, a bottom face 102(a) of lower housing forms a concave surface, thus enabling a close fit of PAPR 100 against the outside of the user’s protective mask when PAPR 100 is attached at outlet opening 103 to the inlet on the user’s protective mask, thus minimizing any impairment of visibility that may be caused by larger assemblies.

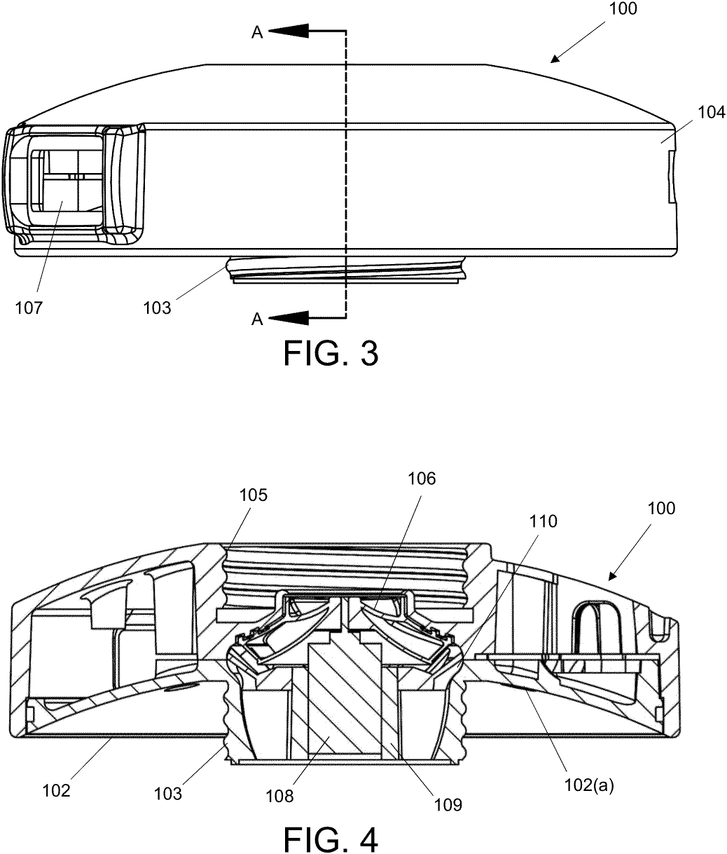

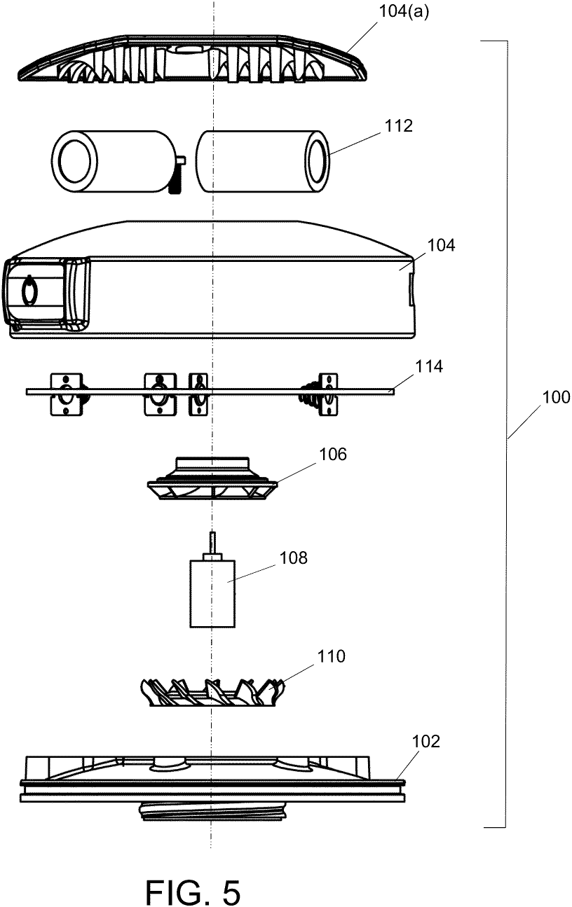

Next and with reference to FIGS. 3-5, PAPR 100 may be powered by batteries 112 that are positioned inside of PAPR 100. In an exemplary configuration, batteries 112 may comprise by way of non-limiting example lithium batteries, such as CR123 batteries, thus providing a self-contained power source on PAPR 100. To enable replacement and/or servicing of batteries 112, a removable battery cover 104a is provided in upper housing 104. Likewise in certain exemplary configurations, a remote battery pack connection port may provide an alternative to the on-board battery power in the event that on-board batteries 112 have drained. Likewise, PAPR control electronics 114 are similarly housed within the interior of PAPR 100 and may include power controls, selection of operational modes, and such other electronic control features as may occur to those skilled in the art. A manually operable on/off switch 107 may be provided on the exterior of the housing that is readily accessible to the user, and that is in electrical communication with electronics 114 to selectively operate PAPR 100.

With particular reference to the cross-sectional view of FIG. 4, PAPR 100 includes a motor 108 mounted within a motor mount 109 in lower housing 102. Motor 108 has a motor shaft that is affixed to impeller 106 to cause impeller 106 to rotate under power of motor 108. In an exemplary configuration, motor 108 may comprise a 4.5V motor, which is sufficient to operate impeller 106 without appreciably increasing the weight of the overall assembly. The shaft of motor 108 mounts impeller 106 so that impeller 106 sits immediately adjacent to the bottom portion of internally threaded inlet opening 105. Such bottom portion of internally threaded inlet opening 105 forms an impeller receiver 120 (FIG. 7) having a contour that matches the contour of the top side of impeller 106, as discussed in greater detail below. Further and as described in greater detail below, a flow straightener 110 is fixed within lower housing 102. Flow straightener 110 includes fins 140 that have outer edges that are positioned immediately adjacent and parallel to outer edges of fan blades 130 on impeller 106, such that as impeller 106 rotates to draw air into the top of impeller 106 and radially expel it out from the bottom of impeller 106, such radially expelled airflow immediately impacts fins 140 on flow straightener 110 to redirect the airflow downward and out through outlet opening 103 in lower housing 102.

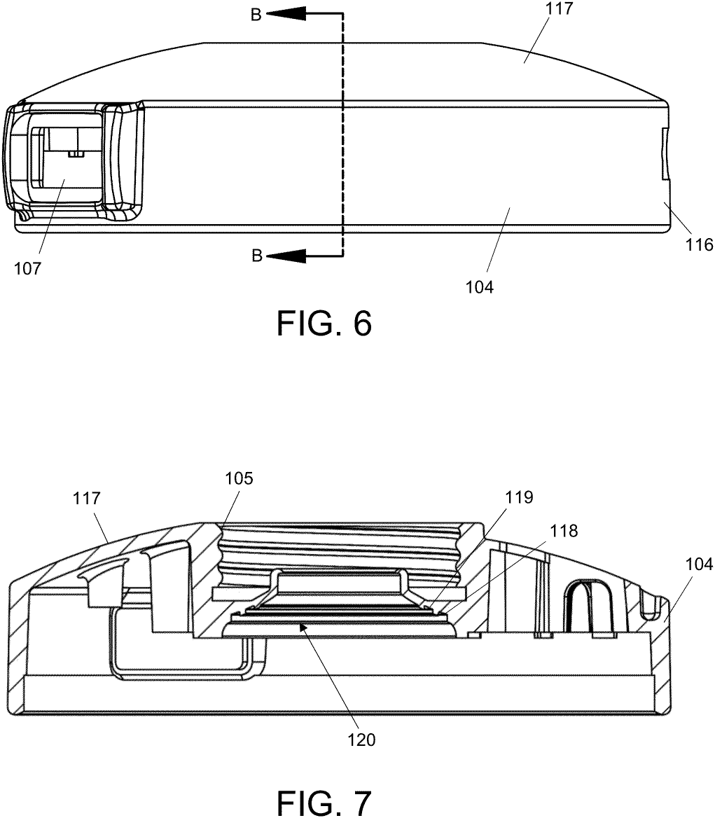

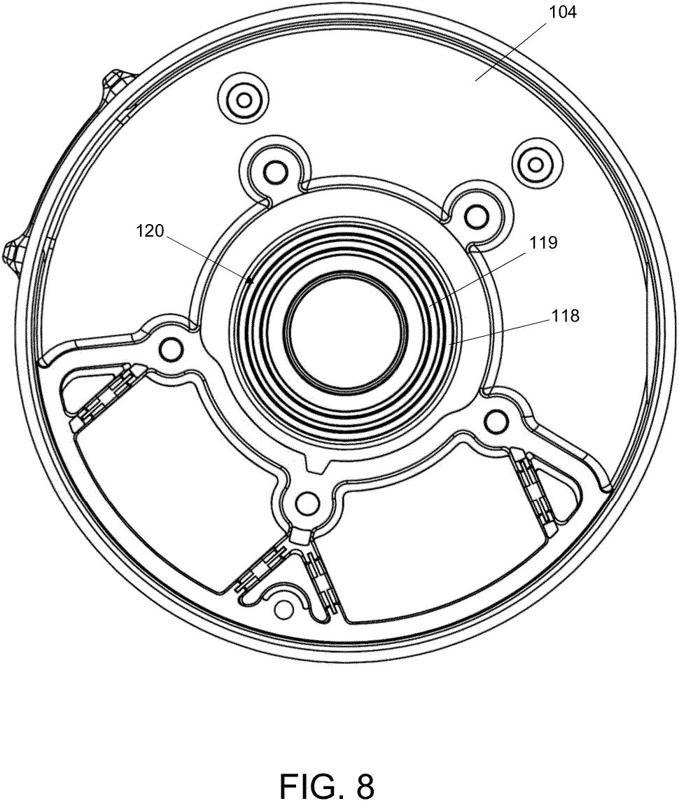

Next, FIGS. 6, 7, and 8 show side, section, and bottom views, respectively, of upper housing 104. Upper housing 104 has a generally cylindrical sidewall 116 and a convex top wall 117, with inlet opening 105 extending centrally downward into convex top wall 117. A central portion of top wall 117 that is recessed into inlet opening 105 defines impeller receiver 120, again the contour of which matches the contour of the top surface of centrifugal impeller 106. Impeller receiver 120 defines an outer circumferential notch 118 and an inner circumferential notch 119. Outer circumferential notch 118 matches the contour of an outer upwardly extending rim 136 on impeller 106, and inner circumferential notch 119 matches the contour of an inner upwardly extending rim 134 on impeller 106, providing a close but nonetheless noncontact fit (i.e., sufficient to enable rotation of impeller 106) between the top of impeller 106 and the underside of impeller receiver 120.

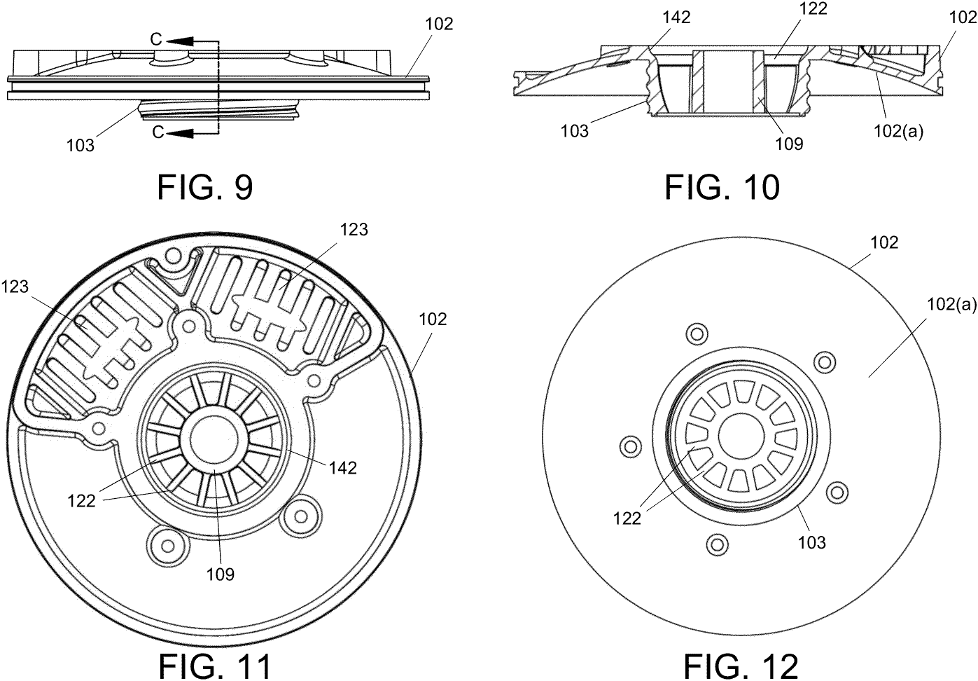

Likewise, FIGS. 9, 10, 11, and 12 show side, cross-sectional, top, and bottom views, respectively of lower housing 102. As best viewed in FIGS. 9 and 10, the underside 102(a) of lower housing 102 defines a convex bottom face from the outer edges of lower housing 102 to centrally located externally threaded outlet opening 103. A plurality of radial ribs 122 extend between motor mount 109 and the interior wall of outlet opening 103. The top end of outlet opening 103 forms flow straightener receiver 142, which fixedly mounts flow straightener 110 on lower housing 102. In certain configurations, flow straightener 110 may optionally be formed integrally with lower housing 102. Battery receivers 123 may likewise be provided on the top face of lower housing 102 forming cradles to removably receive and hold batteries 112.

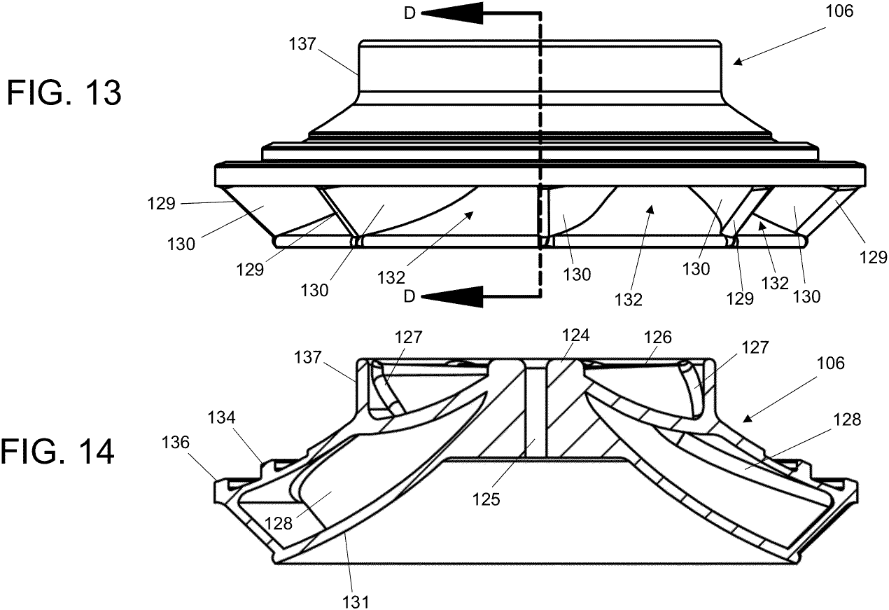

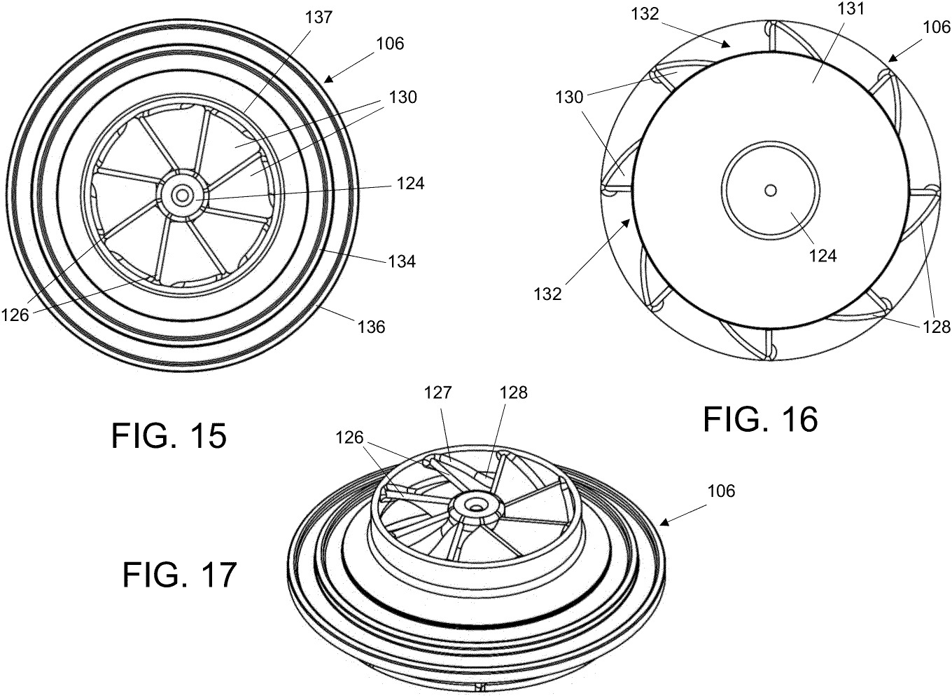

Next, FIGS. 13, 14, 15, 16, and 17 show side, cross-section, top, bottom, and perspective views, respectively, of impeller 106. Impeller 106 includes fan blades 130 that direct airflow downward through impeller 106 and out of radial impeller outlets 132. The top surface of impeller 106 includes inner, upwardly extending rim 134, outer, upwardly extending rim 136, and fan blade outer rim 137. As mentioned above, rims 134 and 136, along with the rest of the profile of the top of impeller 106, match the contour of impeller receiver 120 on upper housing 104. This mating configuration of impeller 106 and impeller receiver 120 makes it more difficult for air travelling through PAPR 100 to recirculate from the outlet opening to the inlet of impeller 106. Fan blades 130 extend outward from central hub 124 (which in turn has a motor mounting shaft extending therethrough that affixes to the shaft of motor 108) to an interior face of fan blade outer rim 137. Each fan blade 130 has a fan blade top edge 126 extending in a straight line outward from central hub 124 to the edge of the fan blade 130 immediately adjacent fan blade outer rim 137. Each fan blade 130 likewise has an outer edge that extends down from top edge 126 to define an air channel between adjacent fan blades. An upper portion 127 of the outer edge of each fan blade 130 extends downward from the fan blade top edge 126 along a curve, and a lower portion 127 of the outer edge of each fan blade 130 extends downward from the upper portion 127 along a curve following the contour of the underside of the impeller body, with the curve of the lower portion 127 being less steep than the upper portion 126. This configuration provides each fan blade 130 with a generally S-shaped configuration that results in air that is drawn into the top of impeller 106 being directed generally radially outward through radial impeller outlets 132 on the bottom of impeller 106. The bottom of each fan blade 130 forms a fan blade outer edge 129 that forms a generally straight line positioned at an angle that matches an angle of interior straight fin edges 144 on fins 140 of flow straightener 110, as discussed in further detail below. As best viewed in FIGS. 14 and 16, the bottom of impeller 106 forms a solid, partial-bell-shaped closed bottom wall 131.

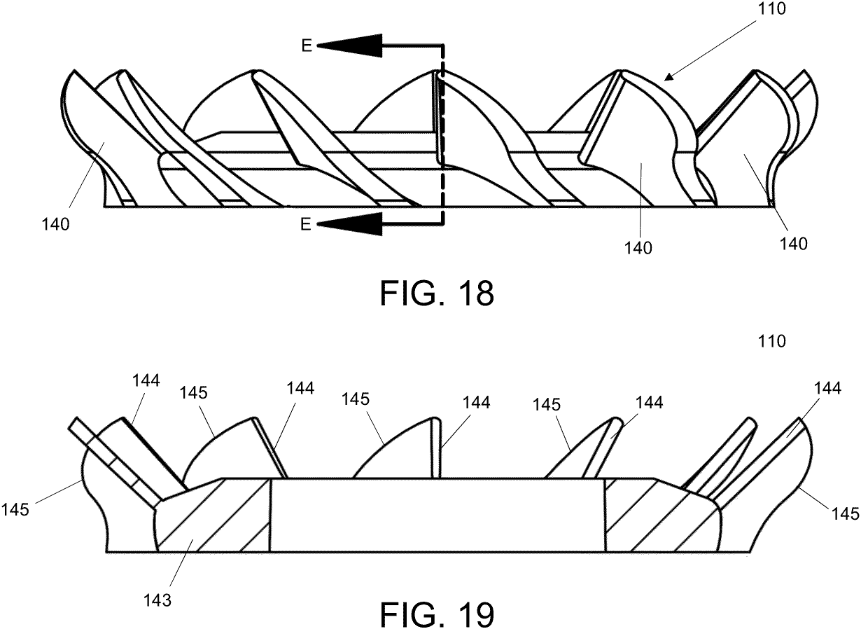

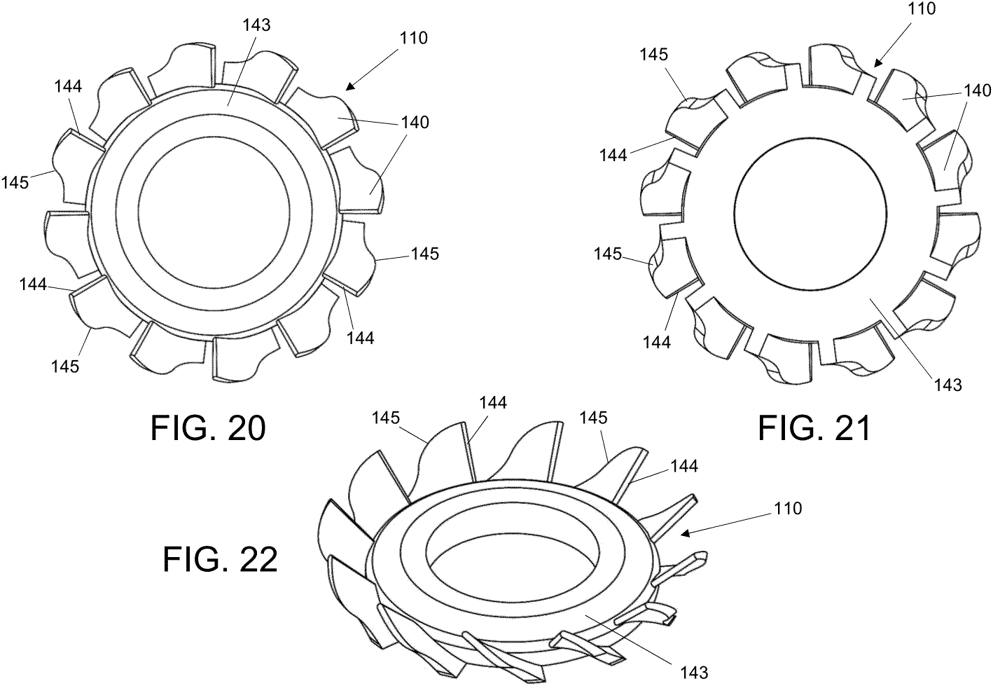

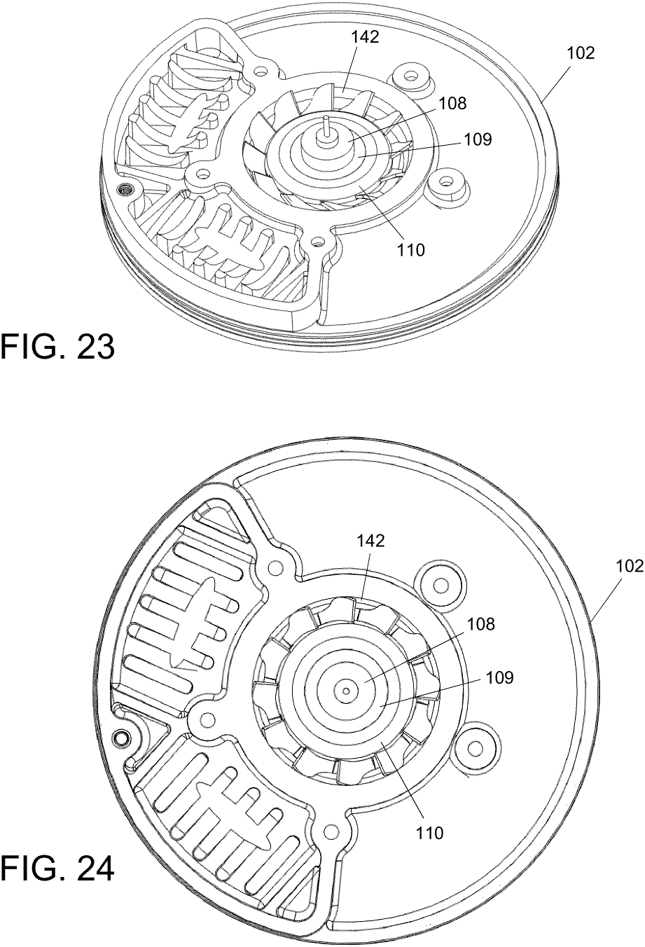

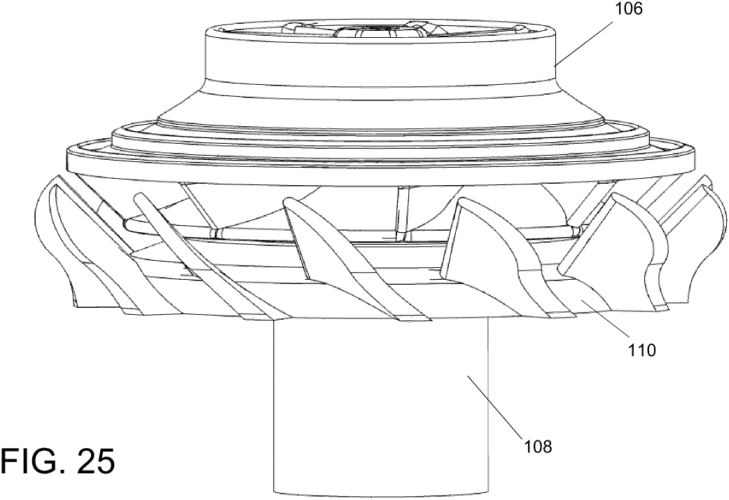

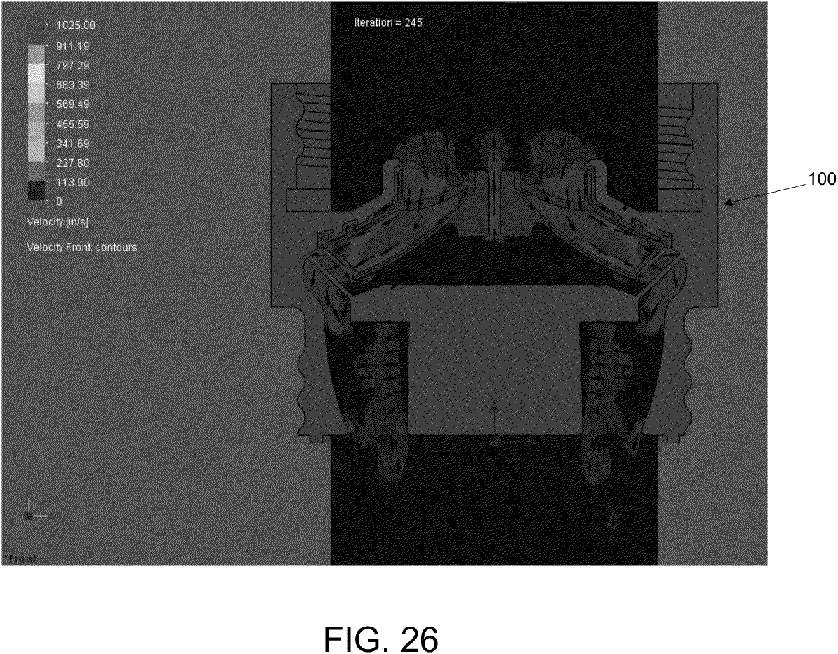

Next, FIGS. 18, 19, 20, 21, and 22 show side, cross-sectional, top, bottom, and perspective views, respectively, of flow straightener 110. Flow straightener 110 includes a plurality of fins 140, each having an interior straight fin edge 144 and a generally S-curved outer edge 145, which fins further aid in directing flow through PAPR 100. Each interior straight fin edge 144 extends outward from a central flow straightener hub 143 at an angle that matches the angle of fan blade outer edges 129 on impeller 106. As best shown in FIGS. 23 and 24, flow straightener 110 is fixedly positioned within a flow straightener receiver 142 in lower housing 102, with motor 109 extending upward through an open interior of flow straightener 110. As best viewed in FIG. 25 (showing the combination of motor 108, flow straightener 110, and centrifugal impeller 106), as motor 108 rotates impeller 106 (with flow straightener 110 remaining fixed), centrifugal impeller 106 pulls air from the top internally threaded inlet opening 105 of PAPR 100 (and through an attached cartridge filter), through the top of impeller 106, accelerating the airflow towards radial outlets 132 of impeller 106. That radial outflow from impeller 106 then immediately contacts fins 140 on flow straightener 110, redirecting that flow downward to drive the airflow out of the bottom of PAPR 100 through externally threaded outlet opening 103 (and into a user’s respirator mask). FIG. 26 shows a velocity diagram as air is pulled through PAPR 100 configured as above during operation, in which the radial outflow from impeller 106 is preferably directed immediately downward at flow straightener 110 to preferably avoid having the spiral around the interior of PAPR 100 as with conventional PAPR constructions.

In exemplary configurations, a PAPR 100 configured in accordance with at least certain aspects of the above-described invention may enable the PAPR 100 to be operated in temperatures from -30° C. to 49° C., and may have operational modes of 45-50 liters per minute (“LPM”) in a fixed operational mode, and 25-65 LPM in a breath rate responsive (“BRR”) operational mode as controlled by the electronics 114 inside of PAPR 100.

In summary, a PAPR configured in accordance with at least certain aspects of the invention will provide improved airflow efficiency and reduced bulk over previously known PAPR configurations, making it a more practical and comfortable solution for respiratory protection in a variety of operational settings. The unique impeller and flow straightener design described herein may ensures a more direct and efficient path for air movement, reducing the risk of harmful particulates and gases reaching the user’s respiratory system.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

1. A powered air purifying respirator (“PAPR”), comprising:
a PAPR body having an upper housing having an inlet configured for attachment to a filter cartridge, and a lower housing having an outlet configured for attachment to a protective mask;
an impeller rotatably mounted within the PAPR body, said impeller having an impeller body defining an impeller air inlet aligned with the inlet on the upper housing and an impeller air outlet configured to radially outflow air from the impeller; and
a fixed flow straightener in the PAPR body having a plurality of fins positioned immediately adjacent to and conforming to the shape of the impeller air outlet, wherein the fins are configured to redirect the radial outflow of air from the impeller to an axial airflow through the outlet in the lower housing.

2. The PAPR of claim 1, wherein said lower housing has a concave bottom external wall surrounding said outlet.

3. The PAPR of claim 1, said impeller further comprising a plurality of S-shaped fan blades.

4. The PAPR of claim 3, said fan blades further comprising a top edge extending in a straight line outward from a central hub of said impeller.

5. The PAPR of claim 3, said fan blades further comprising an outer edge upper portion extending downward from a blade top edge along a first curve.

6. The PAPR of claim 5, each said outer edge of each said fan blade further comprising an outer edge lower portion extending downward from said outer edge upper portion along a second curve following an underside of the impeller body.

7. The PAPR of claim 6, wherein said second curve is less steep than said first curve.

8. The PAPR of claim 3, said impeller further comprising a partial-bell-shaped closed bottom having a central hub.

9. The PAPR of claim 8, said PAPR further comprising a motor in said PAPR body, said motor drivingly attached to a motor shaft receiver in said central hub of said impeller.

10. The PAPR of claim 3, wherein said fins on said flow straightener further comprise S-shaped fins.

11. The PAPR of claim 10, wherein an outer edge of each said fin extends at an angle that is parallel to an angle of an outer edge of each said fan blade on said impeller.

12. A powered air purifying respirator (“PAPR”), comprising:
a PAPR body having an upper housing having an inlet configured for attachment to a filter cartridge, and a lower housing having an outlet configured to direct purified air to a protective mask;
a centrifugal impeller rotatably mounted within the PAPR body, said impeller having an impeller body defining an impeller air inlet aligned with the inlet on the upper housing and a plurality of S-shaped fan blades configured to radially outflow air from the impeller; and
a fixed flow straightener in the PAPR body having a plurality of fins positioned immediately adjacent to and conforming to the shape of an end of each said S-shaped fan blade, wherein the fins are configured to redirect the radial outflow of air from the impeller to an axial airflow through the outlet in the lower housing.

13. The PAPR of claim 12, wherein said lower housing has a bottom, concave external wall surrounding said outlet.

14. The PAPR of claim 12, said impeller further comprising a partial-bell-shaped closed bottom wall having a central hub.

15. The PAPR of claim 14, wherein said fan blades extend between said partial-bell-shaped closed bottom wall and a top of said impeller.

16. The PAPR of claim 12, further comprising a motor drivingly attached to said impeller.

17. The PAPR of claim 12, wherein said fins on said flow straightener further comprise S-shaped fins.

18. The PAPR of claim 17, wherein an outer edge of each said fin extends at an angle that is parallel to an angle of an outer edge of each said fan blade on said impeller.
